(19) United States
(12) Patent Application Publication
(10) Pub. No.: US 2007/0091005 A1
(43) Pub. Date: Apr. 26, 2007

(54) Multi-band loopole antennae

(76) Inventors: Ernest T. Tsui, Cupertino, CA (US); Setul M. Shah, Folsom, CA (US)

Correspondence Address: INTEL/BLAKELY, 12400 WILSHIRE BOULEVARD, SEVENTH FLOOR, LOS ANGELES, CA, 90025-1030, US

(21) Appl. No.: 11/583,493

(22) Filed: Oct. 18, 2006

Related U.S. Application Data
(60) Provisional application No. 60/729,310, filed on Oct. 21, 2005.

(51) Int. Cl. H01Q 11/12

(52) U.S. Cl. 343/742; 343/867

(57) ABSTRACT

Described herein are antennae that may provide a relatively compact design that has resonances at UHF (700 MHz), L-band (1.6 GHz), and S-band (2 GHz) to allow good performance in all of these bands. Normally television antennas are relatively large and on the order of a foot long or more due to the long wavelengths of the VHF/UHF band, however the antennae described herein may be relatively small.

This application claims the benefit of U.S. Provisional Application 60/729,310 filed Oct. 21, 2005.

### TECHNICAL FIELD

Embodiments of the invention relate to antennae. More particularly, embodiments of the invention relate to multi-band antennae that may be used for mobile television reception.

### BACKGROUND

Existing antennae for portable television reception are generally in the form of rabbit ears or extendable monopoles, which are relatively narrowband. For optimal reception the user may be required to adjust the antenna length and orientation for each channel. This may result in poor reception and/or a time-consuming and possibly frustrating antenna adjusting effort required of the viewer. Thus, current antennae for portable television reception may result in an unsatisfactory viewing experience.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention is illustrated by way of example, and not by way of limitation, in the figures of the accompanying drawings in which like reference numerals refer to similar elements.

FIGS. 1a and 1b illustrate embodiments of loopole antennae.

FIG. 2 illustrates one embodiment of a four-petal antenna.

FIG. 3 is a three-dimensional view of one embodiment of a four-petal antenna.

FIG. 4 illustrates an antenna pattern at 700 MHz for one embodiment of a four-petal antenna such as the antenna of FIG. 3.

FIG. 5 illustrates an antenna pattern at 1600 MHz for one embodiment of a four-petal antenna such as the antennae of FIG. 3.

FIG. 6 is a three-dimensional view of one embodiment of a two-petal antenna.

FIG. 7 illustrates an antenna pattern at 700 MHz for one embodiment of a two-petal antenna such as the antenna of FIG. 6.

FIG. 8 illustrates a first view of an antenna pattern at 1600 MHz for one embodiment of a two-petal antenna such as the antenna of FIG. 6.

FIG. 9 illustrates a second view of an antenna pattern at 1600 MHz for one embodiment of a two-petal antenna such as the antenna of FIG. 6.

FIG. 10 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

For the new loopole due to the Omnidirectionality in the Azimuthal directions and gain in the elevation directions that matter (e.g., 0 deg. Horizontally to about 60-70 deg.), the user may not be required to adjust the antenna as the user will normally not be able to do so if the antenna is built-in and non-protruding from a laptop or handheld system. A significant advantage for the laptop or other mobile device is the compact size of the “loophole”, only a few inches in diameter (for TV applications) and the multi-band nature that alleviates the need for large and multiple antennas for the limited space of present and future notebook computers or other mobile devices that may be used for receiving television signals.

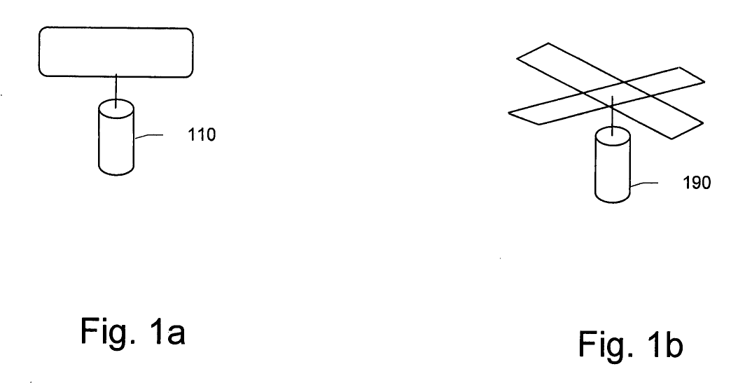

FIGS. 1a and 1b illustrate embodiments of loopole antennae. Described herein are antennae that may provide a relatively compact design that has resonances at UHF (700 MHz), L-band (1.6 GHz), and S-band (2 GHz) to allow good performance in all of these bands. Normally television antennas are relatively large (e.g., rabbit ears, UHF loop antennas, etc.) and on the order of a foot long or more due to the long wavelengths of the VHF/UHF band, however the antennae described herein may be relatively small (e.g., a few inches in diameter see example embodiments in FIGS. 1a and 1b).

One potential benefit of the antennae described herein is that it may be somewhat reconfigurable as a precise given shape may not be required, which may allow good performance with the ability to be tailored to some degree to fit within the specific constraints associated with various corresponding devices. In one embodiment, the antenna may be configured into a “two-petal” arrangement (e.g., see example embodiment in FIG. 1a) and also a “four-petal” arrangement (e.g., see example embodiment in FIG. 1b) that may capture cross polarizations of television signals. For each petal, the loopole can be made from relatively inexpensive components, for example, wire (e.g., 22 or other gauge) or metal plates (as illustrated in FIGS. 1a and 1b).

In one embodiment, the antennae may be configured for different bands by taking the basic quarter-wave monopole length whip antenna and making a loop. Furthermore, the loopole can then be “flattened” so that is made close to the ground plane, but no attachment to ground is made relying on the “image” principal of the basic monopole antenna rather than sticking up. This arrangement may be referred to as the “two petal” flower arrangement of the loopole. A “four-petal” version can be made by using two of the “two-petal” antennae and connecting them in the center to obtain an antenna capable of also picking up the opposite polarizations.

These antennae may also show resonances in the upper bands of L-band and S-band, which may also contain digital television signals in different geographical locations. The antenna may also provide significant gain in the direction of the elevation and may also be essentially omni-Azimuthal with no deep nulls in the Z direction like a normal monopole.

In one embodiment, the two-petal antenna of FIG. 1a may be coupled to coaxial cable 110 (or other type of connection mechanism) to carry signals to and from a displaying device, for example, a laptop computer or other electronic system. The loop portion of the two-petal antenna may have dimensions on the order of 0.5 inches in width and 4.75 inches in length. Other dimensions may be utilized depending on the frequencies to be received and/or fine tuning of the antenna. For example, a width of 0.33 inches with a length of 4.9 inches may be used, or a width of 0.25 inches with a length of 5 inches may be used. Other dimensions may also be used, for example, a width of 0.5 inches with a length of 5 inches may be used.

In one embodiment, the four-petal antenna of FIG. 1b may be coupled to coaxial cable 190 (or other type of connection mechanism) to carry signals to and form the displaying device. The loop portions of the four-petal antenna may have dimensions on the order of 0.5 inches in width and 4.75 inches in length. Other dimensions may be utilized depending on the frequencies to be received and/or fine tuning of the antenna. For example, a width of 0.33 inches with a length of 4.9 inches may be used, or a width of 0.25 inches with a length of 5 inches may be used. Other dimensions may also be used, for example, a width of 0.5 inches with a length of 5 inches may be used.

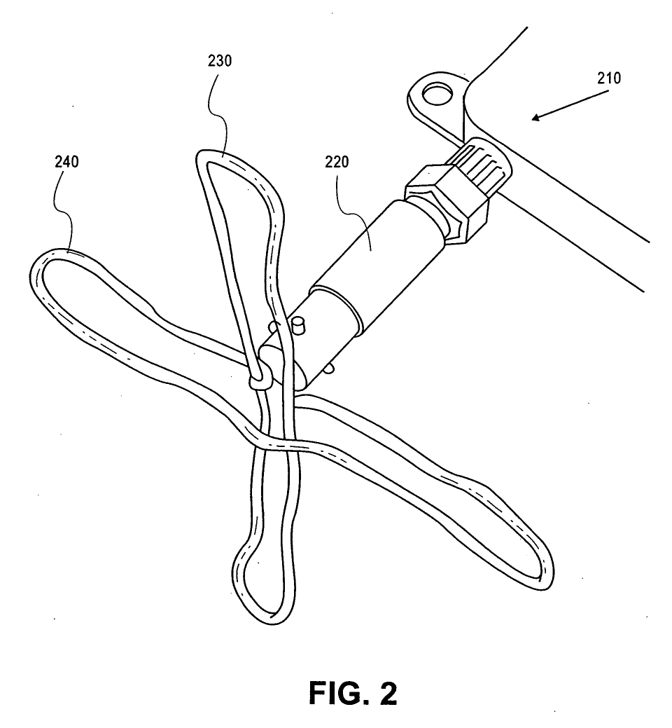

FIG. 2 illustrates one embodiment of a four-petal antenna. The embodiment of FIG. 2 shows an embodiment in which the antenna is constructed of wire that has been formed into four loops or petals. Loop pair 230 and loop pair 240 may be of the dimensions discussed above. The antenna petals may be coupled with electronic system 210 via interface 220, which may include a coaxial structure or other suitable structure to carry signals between the antenna petals and electronic device 210.

As illustrated in FIG. 2, the antenna petals may have a rounded shape that approximates the dimensions set forth above. When constructed of wire or other flexible material the petal shape may be modified by a user to fine tune the characteristics of the antenna to adapt to localized conditions. In other embodiments, the petals may be constructed of a less flexible material, or of a heaver gauge wire, to resist shape modification.

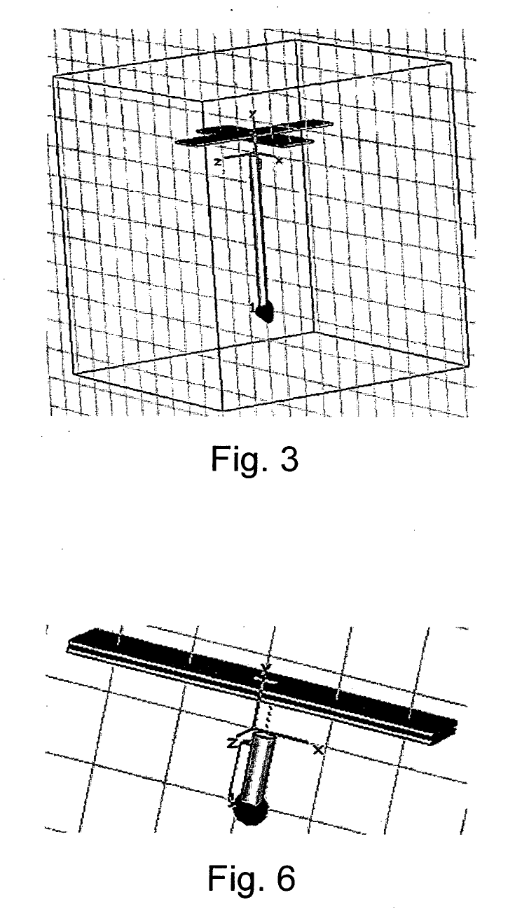

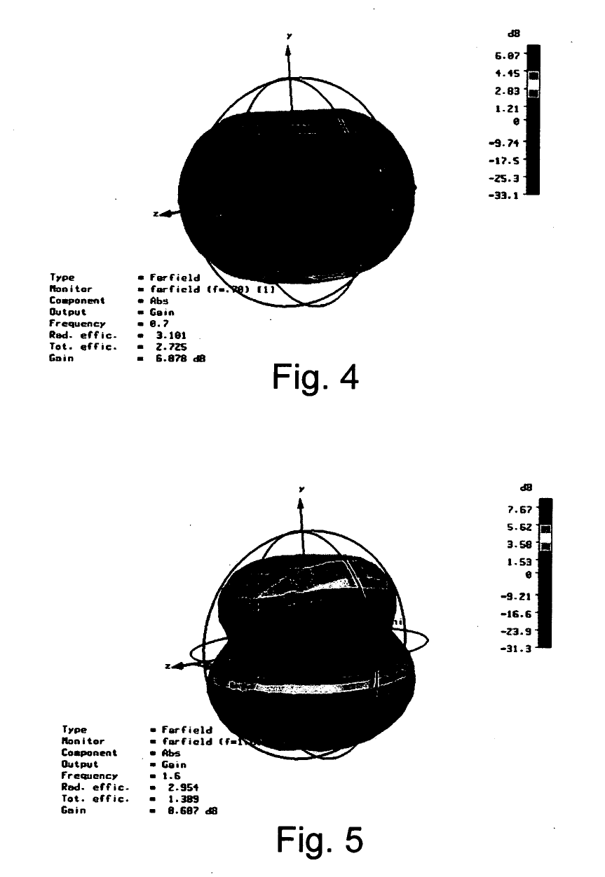

FIG. 3 is a three-dimensional view of one embodiment of a four-petal antenna. FIG. 4 illustrates an antenna pattern at 700 MHz for one embodiment of a four-petal antenna such as the antenna of FIG. 3. FIG. 5 illustrates an antenna pattern at 1600 MHz for one embodiment of a four-petal antenna such as the antenna of FIG. 3.

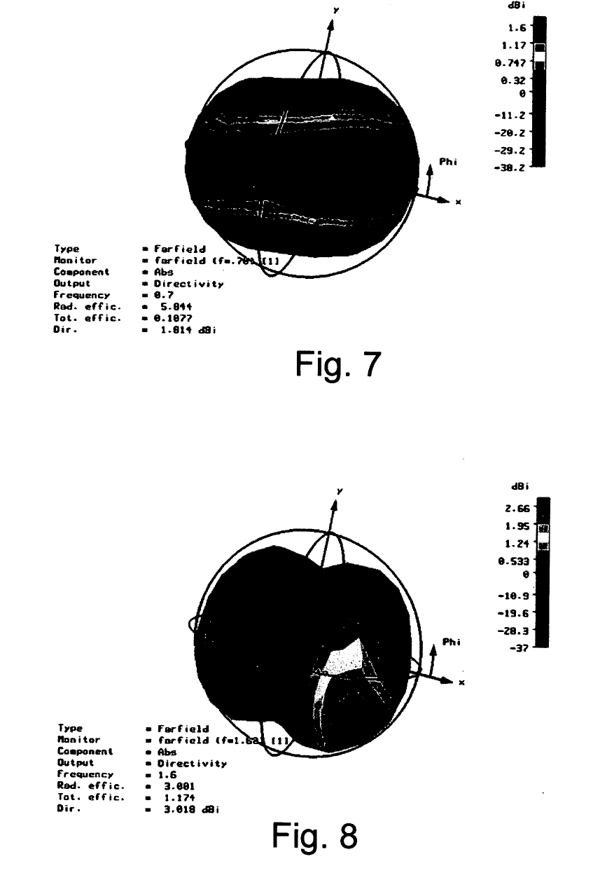

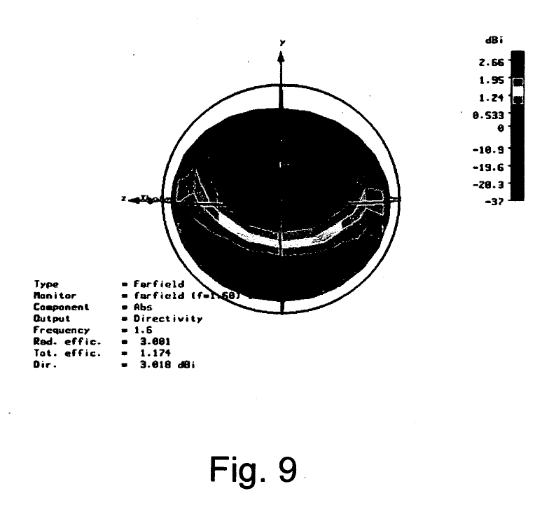

FIG. 6 is a three-dimensional view of one embodiment of a two-petal antenna. FIG. 7 illustrates an antenna pattern at 700 MHz for one embodiment of a two-petal antenna such as the antenna of FIG. 6. FIG. 8 illustrates a first view of an antenna pattern at 1600 MHz for one embodiment of a two-petal antenna such as the antenna of FIG. 6. FIG. 9 illustrates a second view of an antenna pattern at 1600 MHz for one embodiment of a two-petal antenna such as the antenna of FIG. 6.

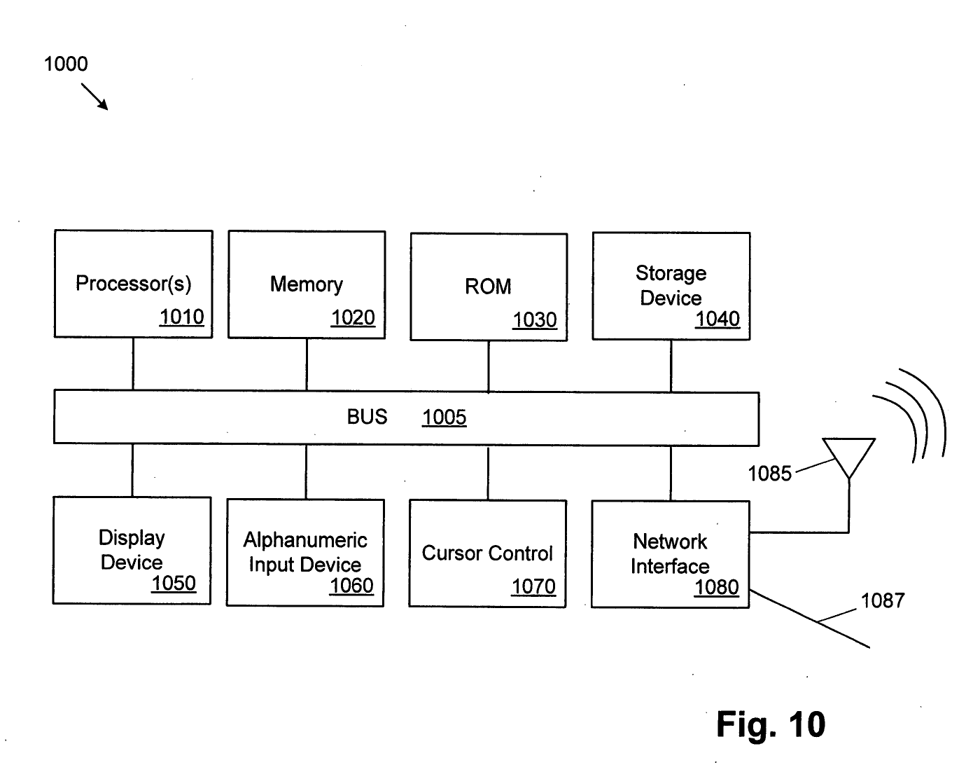

FIG. 10 is a block diagram of one embodiment of an electronic system. The electronic system illustrated in FIG. 10 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 1000 includes bus 1005 or other communication device to communicate information, and processor 1010 coupled to bus 1005 that may process information. While electronic system 1000 is illustrated with a single processor, electronic system 1000 may include multiple processors and/or co-processors. Electronic system 1000 further may include random access memory (RAM) or other dynamic storage device 1020 (referred to as main memory), coupled to bus 1005 and may store information and instructions that may be executed by processor 1010. Main memory 1020 may also be used to store temporary variables or other intermediate information during execution of instructions by processor 1010.

Electronic system 1000 may also include read only memory (ROM) and/or other static storage device 1030 coupled to bus 1005 that may store static information and instructions for processor 1010. Data storage device 1040 may be coupled to bus 1005 to store information and instructions. Data storage device 1040 such as a magnetic disk or optical disc and corresponding drive may be coupled to electronic system 1000.

Electronic system 1000 may also be coupled via bus 1005 to display device 1050, such as a cathode ray tube (CRT) or liquid crystal display (LCD), to display information to a user. Alphanumeric input device 1060, including alphanumeric and other keys, may be coupled to bus 1005 to communicate information and command selections to processor 1010. Another type of user input device is cursor control 1070, such as a mouse, a trackball, or cursor direction keys to communicate direction information and command selections to processor 1010 and to control cursor movement on display 1050.

Electronic system 1000 further may include network interface(s) 1080 to provide access to a network, such as a local area network. Network interface(s) 1080 may include, for example, a wireless network interface having antenna 1085, which may represent one or more antenna(e). Network interface(s) 1080 may also include, for example, a wired network interface to communicate with remote devices via network cable 1087, which may be, for example, an Ethernet cable, a coaxial cable, a fiber optic cable, a serial cable, or a parallel cable.

In one embodiment, network interface(s) 1080 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 1080 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. An antenna structure to receive signals in a frequency range comprising:
a coaxial interface; and
a loop of conductive material, wherein a length of conductive material in the loop is approximately equal to a length of a quarter-wave monopole antenna configured for signals in the frequency range, and further wherein the loop of conductive material has a first dimension that is less than one inch and a second dimension that is greater than one inch.

2. The antenna structure of claim 1 further comprising a second loop of conductive material, wherein a length of conductive material in the second loop is approximately equal to the length of a quarter-wave monopole antenna configured for signals in the frequency range, and further wherein the second loop of conductive material has a first dimension that is less than one inch and a second dimension that is greater than one inch.

3. The antenna structure of claim 2 wherein the first dimension comprises approximately one-half inch and the second dimension comprises approximately 4.75 inches.

4. The antenna structure of claim 1 wherein the first dimension comprises approximately one-half inch and the second dimension comprises approximately 4.75 inches.

5. The antenna structure of claim 1 wherein the conductive material comprises wire having a protective coating.

6. The antenna structure of claim 1 wherein the length of the quarter-wave monopole antenna comprises approximately 10.5 inches.

7. The antenna structure of claim 1 wherein the frequency range includes at least 700 MHz.

8. The antenna structure of claim 7 wherein the frequency range includes at least 1600 MHz.

9. The antenna structure of claim 8 wherein the frequency range includes at least 2000 MHz.

10. A mobile electronic system comprising:
a display device;
a signal processing circuit to cause display device to display data corresponding to a received signal; and
an antenna structure coupled with the signal processing circuit to receive the signal, the antenna structure including a coaxial interface and a loop of conductive material, wherein a length of conductive material in the loop is approximately equal to a length of a quarter-wave monopole antenna configured for signals in the frequency range, and further wherein the loop of conductive material has a first dimension that is less than one inch and a second dimension that is greater than one inch.

11. The system of claim 10 wherein the antenna structure further comprises a second loop of conductive material, wherein a length of conductive material in the second loop is approximately equal to the length of a quarter-wave monopole antenna configured for signals in the frequency range, and further wherein the second loop of conductive material has a first dimension that is less than one inch and a second dimension that is greater than one inch.

12. The system of claim 11 wherein the first dimension comprises approximately one-half inch and the second dimension comprises approximately 4.75 inches.

13. The system of claim 10 wherein the first dimension comprises approximately one-half inch and the second dimension comprises approximately 4.75 inches.

14. The system of claim 10 wherein the conductive material comprises wire having a protective coating.

15. The system of claim 10 wherein the length of the quarter-wave monopole antenna comprises approximately 10.5 inches.

16. The system of claim 10 wherein the frequency range includes at least 700 MHz.

17. The system of claim 16 wherein the frequency range includes at least 1600 MHz.

18. The system of claim 17 wherein the frequency range includes at least 2000 MHz.
